(19) United States
(12) Patent Application Publication
(10) Pub. No.: US 2026/0045854 A1
(43) Pub. Date: Feb. 12, 2026

(54) HYDRAULICALLY POWERED POWER SYSTEMS INCLUDING A FLYWHEEL

(71) Applicant: Illinois Tool Works Inc., Glenview, IL (US)

(72) Inventors: Aditya Vhanesa, Appleton, WI (US); David Radtke, New London, WI (US); Adam Smith, Appleton, WI (US); Grayson Vandenbush, Appleton, WI (US)

(21) Appl. No.: 19/296,487

(22) Filed: Aug. 11, 2025

Related U.S. Application Data
(60) Provisional application No. 63/682,054, filed on Aug. 12, 2024.

(51) Int. Cl. H02K 7/18; F03G 3/08; F15B 15/18; H02K 7/02

(52) U.S. Cl. CPC H02K 7/1815; F03G 3/08; F15B 15/18; H02K 7/02

(57) ABSTRACT

A hydraulically powered power system comprises: a hydraulic motor configured to convert an input hydraulic flow to motor power; a drive assembly drivingly coupled to the hydraulic motor to receive the motor power, the drive assembly comprising one or more drive shafts; a generator drivingly coupled to the drive assembly and configured to convert the motor power to an electrical output; and a flywheel drivingly coupled to at least one of the one or more drive shafts of the drive assembly, wherein the flywheel is configured to resist changes in a rotational speed of the drive assembly.

### RELATED APPLICATIONS

The present application claims the benefit of U.S. Provisional Patent Application Ser. No. 63/682,054, filed Aug. 12, 2024, entitled “HYDRAULICALLY POWERED POWER SYSTEMS INCLUDING A FLYWHEEL.” The entirety of U.S. Provisional Patent Application Ser. No. 63/682,054 is expressly incorporated herein by reference.

### FIELD OF THE DISCLOSURE

This disclosure relates generally to power systems including generators powered by motors and, more particularly, to hydraulically powered power systems comprising generators drivingly coupled to hydraulic motors.

### BACKGROUND

Hydraulically powered power systems use hydraulic fluid to transfer power. For example, a hydraulically powered power system may include a pump which pumps hydraulic fluid through a hydraulic circuit comprising a hydraulically powered device. For example, the pump may power a hydraulically driven motor, thereby actuating the motor to generate and output mechanical power, e.g., to power a generator.

### SUMMARY

Hydraulically powered power systems having a generator drivingly coupled to a hydraulic motor by a drive assembly having a flywheel are disclosed, substantially as illustrated by and described in connection with at least one of the figures, as set forth more completely in the claims.

### BRIEF DESCRIPTION OF THE DRAWINGS

FIG. 1A illustrates a block diagram of a first example hydraulically powered power system, in accordance with aspects of this disclosure;

FIG. 1B illustrates a block diagram of a second example hydraulically powered power system, in accordance with aspects of this disclosure;

FIG. 1C illustrates a block diagram of a third example hydraulically powered power system, in accordance with aspects of this disclosure;

FIGS. 2A and 2B illustrate front and rear views, respectively, of an example flywheel for use in a hydraulically powered power system, in accordance with aspects of this disclosure; and

FIG. 3 illustrates a cross-sectional view of the example flywheel of FIGS. 2A and 2B, in accordance with aspects of this disclosure.

The figures are not necessarily to scale. Where appropriate, similar or identical reference numbers are used to refer to similar or identical components.

### DETAILED DESCRIPTION

Disclosed example hydraulically powered power systems include a flywheel coupled to a drive shaft of a drive assembly drivingly coupling a generator to a hydraulic motor.

A disclosed example hydraulically powered power system includes a generator, which is used to generate an electrical output (e.g., alternating current (“AC”) power and/or direct current (“DC”) power). The generator generates the electrical output by being drivingly coupled to a mechanical power source such that the generator receives a mechanical power (e.g., a rotational power) from the power source. Accordingly, in some disclosed examples, the generator is drivingly coupled to a hydraulic motor (e.g., via one or more drive shafts). The hydraulic motor generates a motor power (e.g., a rotational power), and the generator receives the motor power and converts the motor power to the electrical output. The hydraulic motor may receive input hydraulic flow of a hydraulic fluid from a hydraulic pump, which pumps the hydraulic fluid through a hydraulic circuit comprising the hydraulic pump and the hydraulic motor. Accordingly, the amount of motor power generated by the hydraulic motor (e.g., as measured in rotations per minute (“RPM”) of a drive shaft) may depend on a flow rate of the hydraulic fluid (e.g., measured in cubic meters per second (“cms”), cubic feet per second (“cfs”), gallons per minute (“gpm”), etc.) pumped by the hydraulic pump. The hydraulic pump generates the input hydraulic flow of the hydraulic fluid by receiving an input power (e.g., a mechanical power) and converting the input power into the input hydraulic flow. Accordingly, the hydraulic pump may be coupled to a power source (e.g., an engine), to provide the input power to the hydraulic pump. Accordingly, in some disclosed example hydraulically powered power systems, input power is generated by an engine, a hydraulic pump receives the input power and converts the input power to an input hydraulic flow, a hydraulic motor receives the input hydraulic flow and converts the input hydraulic flow to a motor power, and a generator receives the motor power and converts the motor power to an electrical output.

In conventional hydraulically-powered systems, an electrical output produced by a generator of a hydraulically powered power system may experience instabilities, which may result from rapid changes in supply and/or demand of the electrical output and/or of a motor power provided to the generator. For example, the voltage, current, frequency and/or other characteristics of the electrical output of conventional hydraulically powered power systems may experience such instability. Instabilities in one or more parameters of the electrical output are typically undesirable, and can be problematic for devices and/or systems receiving the electrical output. For example, if a welding torch powered by the electrical output is conducting a welding operation, instabilities or sharp changes in, e.g., a voltage of the electrical power may cause difficulties such as an uneven weld, a termination of a welding arc, spatter, and/or other such problems which may lengthen a weld process and/or decrease the quality of a weld.

In some examples, fluctuations in motor power provided to a generator of a hydraulically powered power system can result in unstable and/or sharp changes in one or more parameters of the electrical output. Such sharp changes may be caused by, e.g., fluctuating load demands of one or more devices (other than the generator) powered by a hydraulic motor of the hydraulically powered power system (e.g., a mechanically powered device receiving a motor power also received by the generator) and/or fluctuating load demands of one or more devices (other than the hydraulic motor) powered by a hydraulic pump of the hydraulically powered power system (e.g., a hydraulically powered device receiving an input hydraulic flow also received by the hydraulic motor). Variables introduced by fluid mechanics of hydraulic fluid provided to a hydraulic motor of a hydraulic circuit as input hydraulic flow can also cause fluctuation in motor power generated by the hydraulic motor that are not directly determined by variances in one or more parameters of an input power (e.g., rotations per minute (“RPM”) of a drive shaft) provided to a hydraulic pump that converts the input power to the input hydraulic flow.

Some example hydraulic motors used in example hydraulically powered power systems may have less inertial mass and, thereby, provide less instantaneous torque than one or more other types of motors (e.g., mechanically driven motors). A lower interial mass can be disadvantageous in some contexts. For example, if a generator that is drivingly coupled to a hydraulic motor provides an electrical output (e.g., welding-type power) to a welding torch to conduct a welding operation, a decreased instantaneous torque may make striking a welding arc with the welding torch more difficult, increase an amount of time used by the hydraulically powered power system to change a parameter of welding-type power provided to the welding torch (e.g., a fast transient load), and/or increase undesirable changes in one or more parameters of the welding-type power caused by fluctuations in an input power or an input hydraulic flow of the hydraulically powered power system.

Accordingly, disclosed example hydraulically powered power systems include a flywheel drivingly coupled to a drive shaft of a drive assembly that drivingly couples a generator and a hydraulic motor of the hydraulically powered power system. The flywheel may absorb energy from and/or provide energy to the generator based on fluctuating demands of one or more loads of the generator and/or of one or more loads of one or more other devices receiving power from the hydraulically powered power system. Accordingly, the flywheel may increase the stability of the motor power provided to the generator. Further, the flywheel may increase an inertia of the hydraulically powered power system and/or decrease fluctuations in the motor power provided to the generator. Accordingly, the flywheel may provide greater instantaneous torque and/or reduce an amount of time used by the hydraulically powered power system to respond to a fast transient load.

As used herein, the term “hydraulic motor” includes any device capable of converting fluid pressure into linear or rotary motion. Example hydraulic motors operate by pressurizing fluid from a hydraulic pump into a rotary motion as a motor output shaft is driven by the pressurized fluid acting on one or more components of the hydraulic motor (e.g., gears, pistons, etc.).

As used herein, the term “hydraulic power system” includes a system having a motor, a fluid reservoir, and a pump. The hydraulic power system applies hydraulic pressure to one or more devices to drive motors, shafts, cylinders, and/or other parts of the hydraulic power system.

As used herein, the term “hydraulic pump” describes a device to convert mechanical power into hydraulic energy, thereby serving as a source for mechanical power output, such as to a hydraulic motor.

As used herein, the term “welding-type power” refers to power suitable for welding, plasma cutting, induction heating, air carbon arc cutting (“CAC-A”) and/or hot wire welding/preheating (including laser welding and laser cladding). As used herein, the term “welding-type power supply” refers to any device capable of, when power is applied thereto, supplying welding, plasma cutting, induction heating, CAC-A and/or hot wire welding/preheating (including laser welding and laser cladding) power, including but not limited to inverters, converters, resonant power supplies, quasi-resonant power supplies, and the like, as well as control circuitry and other ancillary circuitry associated therewith.

As used herein, the term “output equipment” refers to one or more devices that receive power (e.g., input power, input hydraulic flow, motor power, an electrical output, welding-type power, etc.) from one or more systems (e.g., a hydraulically powered power system, a hydraulic circuit, etc.), devices (e.g., a power source, a hydraulic pump, a hydraulic motor, a generator, power conversion circuitry), and/or components. For example, output equipment may include one or more hydraulic pumps, one or more hydraulic motors, one or more generators, one or more power conversion circuitries, one or more devices (e.g., any, some, or all of the auxiliary devices described elsewhere herein), and/or one or more tools (e.g., any, some, or all of the tools described elsewhere herein).

As used herein, the term “directly coupled” refers to one or more components being coupled to one or more other components without any intervening components positioned therebetween. For example, a first component being bolted to, screwing into, or otherwise being fastened to a second component such that one or more surfaces of the first component engage one or more surfaces of the second component, the first and second components are directly coupled. Accordingly, as used herein, the term “indirectly coupled” refers to one or more components which are coupled to one another without being directly coupled. For example, if a first component is coupled to a second component, the second component is coupled to a third component, but the first and third components do not engage one another, are not independently attached to one another, and would, if not for the second component, be uncoupled from one another, the first and the third components are indirectly coupled.

As used herein, the term “drivingly coupled” refers to one or more first components being coupled to one or more second components such that a mechanical power (e.g., an input power, a motor power, etc.) may be transferred from the first component to the second component and/or from the second component to the first component.

As used herein, the term “processor” means processing devices, apparatus, programs, circuits, components, systems, and subsystems, whether implemented in hardware, tangibly embodied software, or both, and whether or not it is programmable. The term “processor” as used herein includes, but is not limited to, one or more computing devices, hardwired circuits, signal-modifying devices and systems, devices and machines for controlling systems, central processing units, programmable devices and systems, field-programmable gate arrays, application-specific integrated circuits, systems on a chip, systems comprising discrete elements and/or circuits, state machines, virtual machines, data processors, processing facilities, and combinations of any of the foregoing. The processor may be, for example, any type of general-purpose microprocessor or microcontroller, a digital signal processing (DSP) processor, an application-specific integrated circuit (ASIC), a graphic processing unit (GPU), a reduced instruction set computer (RISC) processor with an advanced RISC machine (ARM) core, etc. The processor may be coupled to, and/or integrated with a memory storage device.

As utilized herein the terms “circuits,” “circuitry,” “controller,” and “control circuitry” refer to physical electronic components (i.e., hardware) and any software and/or firmware (“code”) which may configure the hardware, be executed by the hardware, and/or otherwise be associated with the hardware. As used herein, for example, a “circuit” may comprise any analog and/or digital components, power and/or control elements (such as a microprocessor, digital signal processor (DSP), software, and the like), discrete and/or integrated components, associated software, hardware, and/or firmware, and/or portions and/or combinations thereof. As used herein, for example, a particular processor and memory storage device may comprise a first “circuit” when executing a first set of one or more lines of code and may comprise a second “circuit” when executing a second set of one or more lines of code. As utilized herein, circuitry is “operable” to, “configurable to,” and/or “configured to” perform a function whenever the circuitry comprises the necessary hardware and code (if any is necessary) to perform the function, regardless of whether performance of the function is disabled or not enabled (for example, by an operator-configurable setting, factory trim, etc.).

As used herein, the term “communications circuitry” refers to physical electronic components (i.e., hardware) and, in some examples, any software and/or firmware (i.e., code) which may configure the hardware, be executed by the hardware, and/or otherwise enable the hardware to communicate with one or more other devices (e.g., with communications circuitry of such one or more other devices). Communications circuitry may include hardware capable of wired and/or wireless communication with one or more other devices. Hardware capable of wired communication may include, e.g., one or more cables or other optical communication mechanisms, one or more computer buses, and/or one or more additional wired mechanisms for communicating with one or more communications networks and/or one or more devices. Hardware capable of wireless communications may include, e.g., one or more transceivers, one or more antennas, one or more modems, one or more local area network (“LAN”) ports, one or more wireless fidelity (“Wi-Fi”) cards, one or more WiMax cards, mobile communications hardware, near-field communication hardware, satellite communication hardware, hardware configured to communicate in accordance with one or more wireless communication protocols (e.g., IrDA, Bluetooth, Wireless USB, Z-Wave, ZigBee, radio frequency identification (“RFID”), one or more other near field communications (“NFC”) protocols, and/or one or more other protocols for close-proximity and/or wireless communication), and/or other hardware for wirelessly communicating with one or more communications networks and/or one or more devices. Communications circuitry may include one or more network interfaces, one or more input-output (“I/O”) interfaces, and/or one or more other interfaces for communicating data (e.g., directly, via one or more communications paths, etc.) to and/or from one or more communications networks. An example network interface may include hardware, firmware, and/or software to communicatively couple communications circuitry to one or more communications networks. A network interface may include and/or be coupled to one or more communication paths. A communication path includes hardware which provides signal interconnectivity between one or more components (e.g., control circuitry and a transceiver). A network interface may include any hardware for transmitting and/or receiving communications (e.g., IEEE 802.X-compliant wireless and/or wired communications hardware). An example I/O interface includes hardware, firmware, and/or software to connect one or more I/O devices to control circuitry (communicatively coupled to, e.g., communications circuitry comprising the I/O interface) for providing input to the control circuitry and/or providing output from the control circuitry. For example, the I/O interface may include a graphics processing unit for interfacing with a display device, a universal serial bus port for interfacing with one or more USB-compliant devices, a Fire Wire, a field bus, and/or any other type of interface. Example I/O device(s) may include a keyboard, a keypad, a mouse, a trackball, a pointing device, a microphone, an audio speaker, a display device, an optical media drive, a multi-touch touch screen, a gesture recognition interface, a magnetic media drive, and/or any other type of input and/or output device. Control circuitry communicatively coupled to an I/O interface may access a non-transitory machine-readable medium via the I/O interface and/or one or more I/O device(s). Examples of a machine-readable medium include optical discs (e.g., compact discs (CDs), digital versatile/video discs (DVDs), Blu-ray discs, etc.), magnetic media (e.g., floppy disks), portable storage media (e.g., portable flash drives, secure digital (SD) cards, etc.), and/or any other type of removable and/or installed machine-readable media.

A “communications network” may include one or more of the Internet, one or more personal area networks (“PAN(s)”), one or more LANs, one or more wide area networks (“WAN(s)”), one or more cellular networks, one or more satellite networks, one or more global positioning systems, one or more other such networks, and/or any combination thereof. A LAN may include, e.g., one or more wired technologies (e.g., Ethernet, USB, etc.) and/or one or more wireless technologies (e.g., Wi-Fi). A PAN may include one or more wired technologies (e.g., USB, FireWire, and/or one or more other computer buses) and/or one or more wireless technologies (e.g., Bluetooth, Wireless USB, IrDA, Z-Wave, ZigBee, RFID, one or more other NFC protocols, and/or one or more other protocols for close-proximity and/or wireless communication). A cellular network may include, e.g., technologies such as LTE, WiMAX, UMTS, CDMA, GSM, 3G, 4G, 5G, 6G, and/or one or more other technologies.

As used, herein, the term “memory,” “memory storage device,” and/or “memory device” means computer hardware or circuitry to store information for use by a processor and/or other digital device. The memory, memory storage device, and/or memory device can be any suitable type of computer memory or any other type of electronic storage medium, such as, for example, read-only memory (ROM), random access memory (RAM), cache memory, compact disc read-only memory (CDROM), electro-optical memory, magneto-optical memory, programmable read-only memory (PROM), erasable programmable read-only memory (EPROM), electrically-erasable programmable read-only memory (EEPROM), a computer-readable medium, or the like. Memory can include, for example, a non-transitory memory, a non-transitory processor readable medium, a non-transitory computer readable medium, non-volatile memory, dynamic RAM (DRAM), volatile memory, ferroelectric RAM (FRAM), first-in-first-out (FIFO) memory, last-in-first-out (LIFO) memory, stack memory, non-volatile RAM (NVRAM), static RAM (SRAM), a cache, a buffer, a semiconductor memory, a magnetic memory, an optical memory, a flash memory, a flash card, a compact flash card, memory cards, secure digital memory cards, a microcard, a minicard, an expansion card, a smart card, a memory stick, a multimedia card, a picture card, flash storage, a subscriber identity module (SIM) card, a hard drive (HDD), a solid state drive (SSD), etc. The memory, memory storage device, and/or memory device can be configured to store code, instructions, applications, software, firmware, and/or data, and may be external, internal, or both with respect to a processor.

As used herein, the term “torch” or “welding-type tool” can include a hand-held or robotic welding torch, gun, or other device used to create the welding arc.

As used herein, the term “welding mode” or “welding operation” is the type and/or modality of process and/or output used by a welding system, such as constant current (“CC”) welding, constant voltage (“CV”) welding, pulse welding, metal inert gas (“MIG”) welding or gas metal arc welding (“GMAW”), tungsten inert gas (“TIG”) welding or gas tungsten arc welding (“GTAW”), flux cored arc welding (“FCAW”), plasma cutting, spray welding, short circuit transfer welding, etc.

As used herein, the term “boost converter” is a converter used in a circuit that boosts a voltage. For example, a boost converter can be a type of step-up converter, such as a DC-to-DC power converter that steps up voltage while stepping down current from its input (e.g., from an energy storage device) to its output (e.g., a load and/or attached power bus). It is a type of switched mode power supply.

As used herein, the term “buck converter” (e.g., a step-down converter) refers to a power converter which steps down voltage (e.g., while stepping up current) from its input to its output.

Features described herein make reference to the accompanying drawings in which exemplary embodiments of the disclosure are shown. Whenever appropriate, the same reference numerals are used throughout the drawings to refer to the same or like parts. However, it should be understood that the systems of this disclosure can be embodied in many different forms and should not be construed as limited to the embodiments set forth herein.

The term “power” is used throughout this specification, for convenience, to describe hydraulic, mechanical, and electrical power. However, the term “power,” as used herein, also includes related measures such as energy, current, voltage, resistance, conductance, and enthalpy. For example, controlling “power” may involve controlling voltage, current, energy, resistance, conductance, and/or enthalpy, and/or controlling based on “power” may involve controlling based on voltage, current, energy, resistance, conductance, and/or enthalpy.

It is to be understood that, as used herein the terms “the,” “a,” or “an,” mean “at least one,” and should not be limited to “only one” unless explicitly indicated to the contrary. Thus, for example, reference to “a component” includes embodiments having two or more such components unless the context clearly indicates otherwise.

As used herein, the word “exemplary” means “serving as an example, instance, or illustration.” The embodiments described herein are not limiting, but rather are exemplary only. It should be understood that the described embodiments are not necessarily to be construed as preferred or advantageous over other embodiments. Moreover, the terms “embodiments of the invention,” “embodiments,” or “invention” do not require that all embodiments of the invention include the discussed feature, advantage, or mode of operation.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that any particular order be inferred.

As utilized herein, “and/or” means any one or more of the items in the list joined by “and/or”. As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y and/or z” means “one or more of x, y and z”. As utilized herein, the term “exemplary” means serving as a non-limiting example, instance, or illustration. As utilized herein, the terms “e.g.” and “for example” set off lists of one or more non-limiting examples, instances, or illustrations. While various features, elements or steps of particular embodiments can be disclosed using the transitional phrase “comprising,” it is to be understood that alternative embodiments, including those that can be described using the transitional phrases “consisting of” or “consisting essentially of,” are implied. Thus, for example, implied alternative embodiments to an apparatus that comprises A+B+C include embodiments where an apparatus consists of A+B+C and embodiments where an apparatus consists essentially of A+B+C.

Disclosed example hydraulically powered power systems comprise: a hydraulic motor configured to convert an input hydraulic flow to motor power; a drive assembly drivingly coupled to the hydraulic motor to receive the motor power, the drive assembly comprising one or more drive shafts; a generator drivingly coupled to the drive assembly and configured to convert the motor power to an electrical output; and a flywheel drivingly coupled to at least one of the one or more drive shafts of the drive assembly, wherein the flywheel is configured to resist changes in a rotational speed of the drive assembly.

In some example hydraulically powered power systems, the hydraulically powered power system further comprises power conversion circuitry electrically coupled to the generator and configured to convert the electrical output to welding-type power.

In some example hydraulically powered power systems, the hydraulically powered power system further comprises output equipment configured to receive the electrical output from the generator. In some such example hydraulically powered power systems, the hydraulically powered power system further comprises power conversion circuitry electrically coupled to the generator and configured to convert the electrical output to welding-type power, wherein the output equipment comprises a welding torch configured to receive the welding-type power from the power conversion circuitry.

In some example hydraulically powered power systems, the hydraulically powered power system further comprises output equipment configured to receive the electrical output from the generator, wherein the output equipment comprises an air compressor.

In some example hydraulically powered power systems, the hydraulically powered power system further comprises output equipment configured to receive the motor power from the drive assembly, wherein the drive assembly further comprises one or more drive assembly couplers configured to drivingly couple the output equipment to at least one of the one or more drive shafts of the drive shaft. In some such example hydraulically powered power systems, the output equipment comprises an air compressor.

In some example hydraulically powered power systems, the drive assembly further comprises one or more drive assembly couplers; and the flywheel is coupled to at least one of the one or more drive assembly couplers to drivingly couple the flywheel to the at least one drive shaft of the one or more drive shafts. In some such example hydraulically powered power systems, the one or more drive assembly couplers comprise at least one of a gearbox, a drive shaft mount, a flange mount, or one or more belts.

In some example hydraulically powered power systems, the one or more drive shafts comprise a first drive shaft drivingly coupled to the hydraulic motor by a first end of the first drive shaft; the first drive shaft comprises a second end opposite the first end of the first drive shaft; and a first end of the flywheel receives the second end of the first drive shaft to couple the flywheel to the first drive shaft. In some such example hydraulically powered power systems, the first end of the flywheel comprises an interior tapered surface; the second end of the first drive shaft comprises an exterior tapered surface; and the interior tapered surface of the first end of the flywheel and the exterior tapered surface of the second end of the first drive shaft are configured to define a tapered fit to couple the flywheel to the first drive shaft.

In some example hydraulically powered power systems, the one or more drive shafts comprise a first drive shaft drivingly coupled to the hydraulic motor by a first end of the first drive shaft; the first drive shaft comprises a second end opposite the first end of the first drive shaft; a first end of the flywheel receives the second end of the first drive shaft to couple the flywheel to the first drive shaft; the or more drive shafts further comprise a second drive shaft drivingly coupled to the generator by a first end of the second drive shaft; the second drive shaft further comprises a second end opposite the first end of the second drive shaft; the flywheel further comprises a second end opposite the first end of the flywheel; and the second end of the flywheel is coupled to the second end of the second drive shaft.

In some example hydraulically powered power systems, the one or more drive shafts comprise a first drive shaft drivingly coupled to the hydraulic motor by a first end of the first drive shaft; the first drive shaft comprises a second end opposite the first end of the first drive shaft; a first end of the flywheel receives the second end of the first drive shaft to couple the flywheel to the first drive shaft; the drive assembly further comprises one or more drive assembly couplers; the flywheel further comprises a second end opposite the first end of the flywheel; and the one or more drive assembly couplers are configured to couple to the second end of the flywheel to drivingly couple the generator to the flywheel.

In some example hydraulically powered power systems, the flywheel is coupled to the hydraulic motor.

In some example hydraulically powered power systems, the flywheel is coupled to the generator.

In some example hydraulically powered power systems, the flywheel defines a radius greater than or equal to 4 inches and less than or equal to 4.5 inches.

In some example hydraulically powered power systems, the flywheel defines a length greater than or equal to 2.25 inches and less than or equal to 3.5 inches.

In some example hydraulically powered power systems, the hydraulically powered power system further comprises a hydraulic pump configured to receive input power and to convert the input power to the input hydraulic flow, wherein the hydraulic pump is hydraulically coupled to the hydraulic motor to form a hydraulic circuit. In some such example hydraulically powered power systems, the hydraulically powered power system further comprises a power source configured to generate the input power, wherein the hydraulic pump is drivingly coupled to the power source to receive the input power. In some such example hydraulically powered power systems, the power source is an engine.

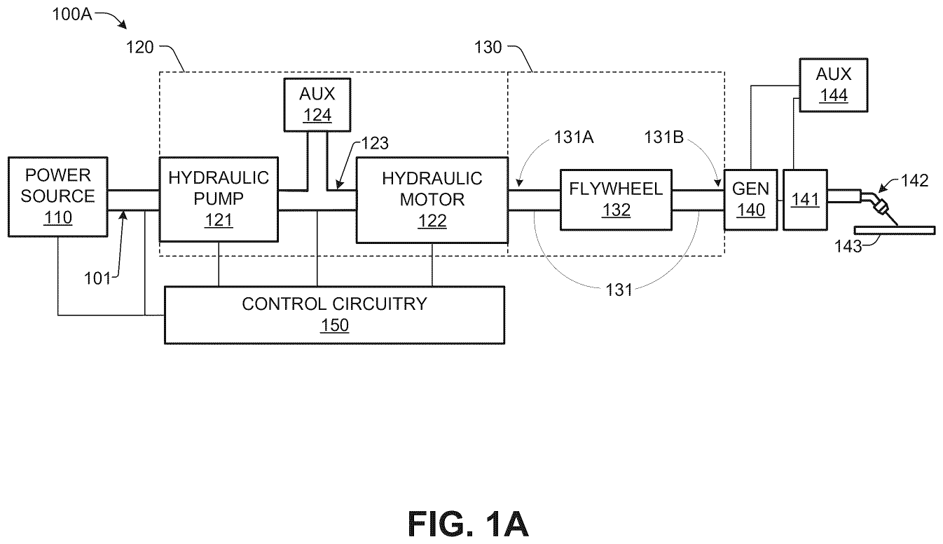

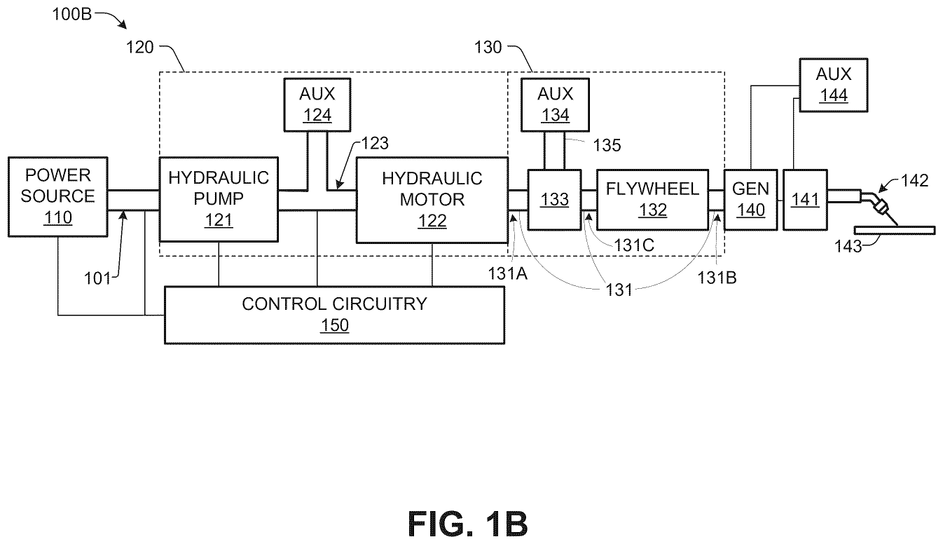

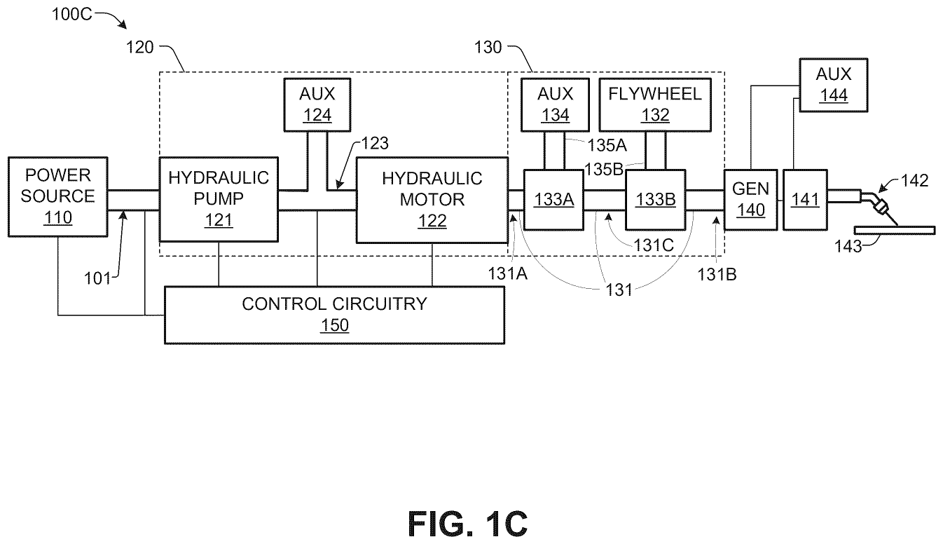

FIG. 1A is a block diagram of an example of a first system 100A. The first system 100A is a hydraulically powered power system, and, in the example depicted in FIG. 1A, includes a power source 110, a hydraulic circuit 120, and a generator 140. The power source 110 (e.g., an engine) generates an input power, which may provide power for the system 100. In some examples, the power source 110 is and/or includes an engine of a truck, a car, or another vehicle. In some examples, the power source 110 is an engine having a capacity up to 65 horsepower and/or up to 3,600 RPM. In some examples, the power source 110 is and/or includes an engine having a capacity up to 25 horsepower and 2,500 RPM, although other power capacity engines are considered. In some examples, the power source 110 is and/or includes an engine operating on four or fewer cylinders (e.g., a two-cylinder piston engine), although other engine types are considered.

The hydraulic circuit 120 includes a hydraulic pump 121, and the hydraulic pump 121 may be drivingly coupled to the power source 110. For example, a first linkage 101 may drivingly couple the hydraulic pump 121 to the power source 110 by, e.g., being directly coupled to the power source 110, coupling to a drive shaft rotated by the power source 110, etc. The first linkage 101 may include one or more drive shafts, one or more clutches, one or more transmissions, one or more belts, one or more gear boxes, one or more keyway couplers, one or more splines, one or more flexible couplers, one or more spider couplers, one or more flex plates, one or more flange mounts, one or more other drive shaft mounts (to, e.g., mount to a drive shaft rotated by the power source 110), and/or one or more other mechanical linkages. Accordingly, the hydraulic pump 121 may receive the input power from the power source 110 and convert the input power to an input hydraulic flow of a hydraulic fluid (e.g., hydraulic oil). The hydraulic pump 121 receives the hydraulic fluid from or via, e.g., a fluid reservoir of the hydraulic circuit 120, a fluid return line of the hydraulic circuit 120, etc.

The hydraulic circuit 120 also includes a hydraulic motor 122, which is hydraulically coupled to the hydraulic pump 121. For example, a second linkage 123 (e.g., one or more pipes, one or more valves, and/or one or more other hydraulic linkages) of the hydraulic circuit 120 may hydraulically couple the hydraulic motor 122 to the hydraulic pump 121. Accordingly, the hydraulic motor 122 may receive the input hydraulic flow and convert the input hydraulic flow to motor power.

In some examples, the hydraulic pump 121 is directly driven by the power source 110, such as by the first linkage 101 including a drive shaft directly coupling the power source 110 to the hydraulic pump 121. In some examples, the hydraulic pump 121 is indirectly driven by the power source 110, such as by being coupled by one or more linkages of the first linkage 101 and/or by one or more other intervening components and/or devices. In some examples, the hydraulic circuit 120 includes the hydraulic pump 121 as the sole hydraulic pump of the hydraulic circuit 120. In other examples, the hydraulic circuit 120 may include a plurality of hydraulic pumps including the hydraulic pump 121 and one or more additional hydraulic pumps. In some such examples, functions of the hydraulic pump 121 described herein may be performed individually by the hydraulic pump 121 and/or collectively by a plurality of hydraulic pumps including the hydraulic pump 121. In some examples, one or more hydraulic pumps of a plurality of hydraulic pumps of the hydraulic circuit 120 receive a respective input power from a respective engine (e.g., by the first system 100A including one or more power sources in addition to the power source 110). In some examples, the power source 110 provides the input power to a plurality of hydraulic pumps including the hydraulic pump 121. In some examples, the hydraulic pump 121 is a fixed displacement pump. In some examples, the hydraulic pump 121 is a variable displacement pump. In some examples, the hydraulic pump 121 has a range of operating pressures, which can be, in some such examples, between approximately 2,500 and 4,500 pounds per square inch (“psi”). In some examples, the hydraulic pump 121 has a range of operating flow rates, and, in some such examples, the hydraulic pump 121 may, thereby, vary a flow rate of the input hydraulic flow received by the hydraulic motor 122.

In some examples, the hydraulic circuit 120 includes the hydraulic motor 122 as the sole hydraulic motor of the hydraulic circuit 120. In other examples, the hydraulic circuit 120 may include a plurality of hydraulic motors including the hydraulic motor 122 and one or more additional hydraulic motors. In some such examples, functions of the hydraulic motor 122 described herein may be performed individually by the hydraulic motor 122 and/or collectively by a plurality of hydraulic motors including the hydraulic motor 122. In some examples, the first system 100A includes a plurality of hydraulic circuits (one or more of the hydraulic circuits being, e.g., configured similarly to the hydraulic circuit 120, configured differently from the hydraulic circuit 120, drivingly coupled to the power source 110, drivingly coupled to one or more other engines, etc.). In some such examples, one or more hydraulic motors of a plurality of hydraulic motors of the hydraulic circuit 120 and/or one or more additional hydraulic circuits receive a respective input hydraulic flow from a respective hydraulic pump. In some examples, the hydraulic pump 121 provides the input hydraulic flow to a plurality of hydraulic motors including the hydraulic motor 122. In some examples, the hydraulic motor 122 is a fixed displacement hydraulic motor. In some examples, the hydraulic motor 122 is a variable displacement hydraulic motor.

In some examples, the hydraulic circuit 120 may additionally include one or more hydraulically powered auxiliary devices 124. The second linkage 123 and/or one or more other linkages may hydraulically couple the one or more hydraulically powered auxiliary devices 124 to the hydraulic pump 121. The hydraulic pump 121 may, thereby, additionally and/or alternatively provide the input hydraulic flow and/or another hydraulic flow to the one or more hydraulically powered auxiliary devices 124 to provide the one or more hydraulically powered auxiliary devices 124 with hydraulic power. In examples, the one or more hydraulically powered auxiliary devices 124 may include one or more of any, some, or all of a hydraulic motor, an air compressor, a welder, an outrigger, a truck stabilizer, a crane, a hydraulic lift, a grinder, and/or one or more other hydraulically powered tools and/or devices. In some examples, the hydraulic pump 121 provides the input hydraulic flow and/or another hydraulic flow to only one of the one or more hydraulically powered auxiliary devices 124. In some examples, the hydraulic pump 121 provides the input hydraulic flow and/or another hydraulic flow to any plurality of the one or more hydraulically powered auxiliary devices 124. In some examples, the hydraulic pump 121 provides the input hydraulic flow and/or another hydraulic flow to none of the one or more hydraulically powered auxiliary devices 124. In some examples, the hydraulic circuit 120 includes any, some, or all of the one or more hydraulically powered auxiliary devices 124. In other examples, the hydraulic circuit 120 includes none of the one or more hydraulically powered auxiliary devices 124.

A drive assembly 130 is drivingly coupled to the hydraulic motor to receive the motor power. The generator 140 is drivingly coupled to the drive assembly 130 and, thereby, the hydraulic motor 122. The drive assembly 130 may include one or more drive shafts, one or more clutches, one or more transmissions, one or more belts, one or more gear boxes, one or more keyway couplers, one or more splines, one or more flexible couplers, one or more spider couplers, one or more flex plates, one or more flange mounts, one or more other drive shaft mounts, and/or one or more other mechanical linkages suitable for coupling to either or both of the hydraulic motor 122 and/or the generator 140 and/or suitable for receiving and/or providing a motor power from one or more other components, devices, and/or systems.

In the example of FIG. 1A, the drive assembly 130 comprises one or more drive shafts 131. In some examples, the drive assembly 130 comprises only one drive shaft of the one or more drive shafts 131, and the drive shaft couples, at an upstream portion 131A, to the hydraulic motor 122 and, at a downstream portion 131B, to the generator 140. In some examples, the one or more drive shafts 131 of the drive assembly 130 may include any plurality of drive shafts. For example, the upstream portion 131A may be a first drive shaft of the one or more drive shafts 131, and the downstream portion 131B may be a second drive shaft of the one or more drive shafts 131. In the example of FIG. 1A, the one or more drive shafts 131 linearly extend between the hydraulic motor 122 and the generator 140. In other examples, a plurality of the one or more drive shafts 131 may not be linearly arranged between the hydraulic motor 122 and the generator 140. Rather, in examples, one or more of drive shafts of the one or more drive shafts 131 may define one or more angles relative to one or more other drive shafts of the one or more drive shafts 131.

By being drivingly coupled to the hydraulic motor 122, the generator 140 may convert the motor power to an electrical output (e.g., AC power and/or DC power). In some examples, the generator 140 is directly driven by the hydraulic motor 122, such as by the one or more drive shafts 131 directly coupling the hydraulic motor 122 to the generator 140. In some examples, the generator 140 is indirectly driven by the hydraulic motor 122, such as by being coupled by one or more drive shafts 131 and by one or more other intervening components and/or devices (e.g., a drive assembly coupler and/or a drive shaft mount). In some examples, the drive assembly 130 integrates the generator 140 with the hydraulic motor 122. For instance, the generator 140 and the hydraulic motor 122 may be enclosed within a single housing of the drive assembly 130 and/or otherwise physically coupled.

The generator 140 may provide the electrical output to one or more tools and/or devices. The generator 140 may additionally and/or alternatively provide the electrical output to a power conversion circuitry 141 (e.g., an individual or combined generator and/or welding power supply). The power conversion circuitry 141 may be used to condition and/or regulate the electrical output of the generator 140 for usage by one or more other devices, such as by converting the electrical output to welding-type power. In some examples, the conditioned and/or regulated power output can be described as a synthetic auxiliary output, with the power being converted over a range of voltage and/or current output curves and/or over a range of values (e.g., 120-240 V, 15-500 amps (“A”), at 50-60 hertz (“Hz”)). In some examples, the first system 100A is configured such that the generator 140 provides a power output for the power conversion circuitry 141 to convert the electrical output from the generator 140 to a synchronous AC power output. The power conversion circuitry 141 may include one or more AC-DC converters, one or more preregulators, and/or one or more other types of converters and/or power conversion circuitries configured to convert input power (e.g., AC power) to one or more other types of power (e.g., DC power, welding-type power, etc.). In some examples, the power conversion circuitry 141, which receives a variable AC input from the generator 140, is configured to generate the synchronous AC power output to one or more tools and/or devices.

In some examples, the generator 140 and/or the power conversion circuitry 141 provide power for one or more tools 142 (i.e., provide the electrical output to the one or more tools 142). In examples, the one or more tools 142 may include any, some, or all of a welding tool (e.g., a welding torch, a wire feeder, and/or one or more other components of a welding system), a wrench, and/or another device. For example, the one or more tools 142 may include a welding torch, and the power conversion circuitry 141 may provide power to the welding torch to perform a welding and/or cutting operation on a workpiece 143. In some examples, the generator 140 and/or the power conversion circuitry 141 provide power to only one of the tools 142. In some examples, the generator 140 and/or the power conversion circuitry 141 provide power to any plurality of the tools 142. In some examples, the generator 140 and/or the power conversion circuitry 141 provide power to none of the tools 142. In some examples, the first system 100A includes any, some, or all of the one or more tools 142. In some examples, the first system 100A includes none of the one or more tools 142.

The generator 140 and/or the power conversion circuitry 141 may additionally and/or alternatively provide power to one or more electrically powered auxiliary devices 144. For example, the generator 140 may provide the electrical output to any, some or all of the electrically powered auxiliary devices 144 and the power conversion circuitry 141 may additionally and/or alternatively regulate the electrical output for any, some, or all of the one or more electrically powered auxiliary devices 144. In examples, the one or more electrically powered auxiliary devices 144 may include one or more of any, some, or all of a motor, an air compressor, a welder, an auxiliary tool, an outrigger, a pump, a truck stabilizer, a crane, a lift, a grinder, a wrench, lighting, and/or one or more other electrically powered tools and/or devices. In some examples, the generator 140 and/or the power conversion circuitry 141 provide power to only one of the one or more electrically powered auxiliary devices 144. In some examples, the generator 140 and/or the power conversion circuitry 141 provide power to any plurality of the one or more electrically powered auxiliary devices 144. In some examples, the generator 140 and/or the power conversion circuitry 141 provide power to none of the one or more electrically powered auxiliary devices 144. In some examples, the first system 100A includes any, some, or all of the one or more electrically powered auxiliary devices 144. In other examples, the first system 100A includes none of the one or more electrically powered auxiliary devices 144.

In the example of FIG. 1A, a flywheel 132 is drivingly coupled to the one or more drive shafts 131 between the upstream portion 131A and the downstream portion 131B. In some examples, the upstream portion 131A may be a first drive shaft of the one or more drive shafts 131, the downstream portion 131B may be a second drive shaft of the one or more drive shafts 131, and the flywheel 132 may be coupled to both the first drive shaft of the upstream portion 131A and the second drive shaft of the downstream portion 131B.

The flywheel 132 is configured to resist changes in a rotational speed of the drive assembly 130 by, for example, increasing an inertial mass of the drive assembly 130. In some examples, by increasing the an inertial mass of the drive assembly 130, the flywheel 132 may reduce a rate of change of one or more parameters of the motor power (e.g., an RPM of the one or more drive shafts 131) provided to the generator 140 based on fluctuating demands of one or more loads of the generator 140. In some examples, if one or more load demands imposed upon generator 140 by the one or more tools 142 and/or by the one or more electrically powered auxiliary devices 144 increases, the flywheel 132 may reduce a rate at which the one or more drive shafts 131 slow in response to the increased load demand (i.e., provide a greater instantaneous torque).

Accordingly, in some examples, the increased inertial mass provided by the flywheel 132 may reduce a magnitude and/or a rate of change of one or more fluctuations in one or more parameters of the electrical output due to a load demand increase in a time between the one or more load demands increasing and, e.g., the increase in the one or more load demands ending and/or while the motor power increases to match the increased load demand. In some examples, an increase in a load demand may be brief, due to the load demand being a fast transient load (i.e., a load demand that changes quickly in magnitude). In some examples, the system 100A may increase a magnitude of the motor power to respond to an increased load demand, such as by modifying operation of the power source 110, the hydraulic pump 121, and/or the hydraulic motor 122 to account for the increase of the increased load demand. In some examples, the flywheel 132 may, thereby, increase a stability of a magnitude of the motor power provided to the generator 140 and/or increase an amount of instantaneous torque which the drive assembly 130 may provide to the generator 140.

In the example of FIG. 1A, the drive assembly 130 includes only one of the flywheel 132, the flywheel 132 is directly coupled to the one or more drive shafts 131, and the drive assembly 130 drivingly couples only the hydraulic motor 122 and the generator 140. However, many additional, distinct configurations of the drive assembly 130 are contemplated. In some examples, the flywheel 132 may be alternatively coupled to the one or more drive shafts 131 (i.e., not directly coupled). In some additional and/or alternative examples, the drive assembly 130 may include any plurality of flywheels 132, and, in some such examples, one or more flywheels of the plurality of flywheels 132 may be directly coupled to the one or more drive shafts 131 and/or one or more flywheels of the plurality of flywheels 132 may be alternatively coupled to the one or more drive shafts 131. In some additional and/or alternative examples, the drive assembly 130 may receive motor power from a plurality of hydraulic motors including the hydraulic motor 122 and/or from one or more other motors. In some additional and/or alternative examples, the drive assembly 130 may provide motor power to a plurality of generators including the generator 140. In some additional and/or alternative examples, the drive assembly 130 may provide the motor power to one or more mechanically powered auxiliary devices in addition to the generator 140.

For example, and referring now to FIG. 1B, an example of a second hydraulically powered power system 100B may include any, some, or all of the components, devices, and/or systems of FIG. 1A (e.g., the power source 110, the hydraulic circuit 120, the drive assembly 130, the generator 140, the power conversion circuitry 141, etc.). As can be seen in the example of FIG. 1B, in the second hydraulically powered power system 100B, the drive assembly 130 provides the motor power to one or more mechanically powered auxiliary devices 134. In examples, the one or more mechanically powered auxiliary devices 134 may include one or more of any, some, or all of a generator, a motor, an air compressor, a welder, an outrigger, a pump, a truck stabilizer, a crane, a lift, a grinder, and/or one or more other mechanically powered tools and/or devices. Accordingly, in some examples, either or both of the systems 100A, 100B may provide one or more types of power (e.g., input hydraulic flow, motor power, and/or an electrical output) to output equipment (i.e., the one or more tools 142 and/or any, some, or all of the auxiliary devices 124, 134, 144).

For example, the drive assembly 130 may include one or more drive assembly couplers 133, which may couple to one or more of the one or more drive shafts 131, the hydraulic motor 122, and/or one or more other devices and/or components of the drive assembly 130 to divert any, some, or all of the motor power from the generator 140 and/or to one or more other devices, systems, and/or components (e.g., the one or more mechanically powered auxiliary devices 134). In some examples, the one or more drive assembly couplers 133 are configured to always divert a set percentage and/or amount of the motor power from the one or more drive shafts 131. In other examples, the one or more drive assembly couplers 133 are configured to selectively and/or controllably divert a set and/or variable percentage and/or amount of the motor power from the one or more drive shafts 131.

As used herein, the term “drive assembly coupler” is used to refer to one or more devices which may, as an independent component and/or as combination of a plurality of components, couple to one or more drive shafts to transfer motor power from the one or more drive shafts. As a non-limiting list of examples, a drive assembly coupler may be and/or include one or more gearboxes, one or more drive shaft mounts, one or more flange mounts, or more belts (e.g., for use with one or more pulleys, cogs, gears, etc.), and/or one or more other coupling components, devices, and/or systems. As used herein, the term “drive shaft mount” is used to refer to one or more devices which may be mounted (e.g., directly coupled) to one or more drive shafts. As a non-limiting list of examples, a drive shaft mount may be and/or include one or more keyway couplers, one or more splines, one or more spider couplers, one or more jaw couplers, one or more shaft couplers, one or more flex plates, one or more flexible couplers, and/or one or more other mounting components, devices, and/or systems.

In the example of FIG. 1B, the drive assembly 130 includes one or more auxiliary linkages 135, which couple the one or more mechanically powered auxiliary devices 134 to the one or more drive assembly couplers 133 to drivingly couple the one or more mechanically powered auxiliary devices 134 to the one or more drive shafts 131 so that the one or more mechanically powered auxiliary devices 134 may receive some or all of the motor power in addition to and/or alternatively to the generator 140. The one or more auxiliary linkages 135 may include one or more drive shafts, one or more clutches, one or more transmissions, and/or one or more other mechanical linkages. In some examples, the one or more mechanically powered auxiliary devices 134 may couple directly to the one or more drive assembly couplers 133 (e.g., such that the drive assembly 130 may not include the one or more auxiliary linkages 135) and/or include a drive assembly coupler to couple to the one or more drive shafts 131 and/or to the hydraulic motor 122 (e.g., such that the drive assembly 130 may not include the one or more drive assembly couplers 133 and/or the one or more auxiliary linkages 135).

In the example of FIG. 1B, the flywheel 132 is positioned, within the drive assembly 130, downstream (i.e., further from the source of the motor power, the hydraulic motor 122) of the one or more drive assembly couplers 133, such that one or more intermediary portions 131C of the one or more drive shafts 131 separate the flywheel 132 from the one or more drive assembly couplers 133. In other examples, the flywheel 132 may be positioned upstream and/or downstream from any, some, or all of the one or more drive assembly couplers 133. For example, the flywheel 132 may be positioned upstream of all of the one or more drive assembly couplers 133, downstream of all of the one or more drive assembly couplers 133, or upstream of one or more of the one or more drive assembly couplers 133 and downstream of one or more of the drive assembly couplers 133.

In some examples, the one or more intermediary portions 131C may be a portion of a single drive shaft of the one or more drive shafts 131. In some examples, the one or more intermediary portions 131C may be and/or include one or more drive shafts of the drive shafts 131 that are distinct from one or more drive shafts of the upstream portion 131A and/or one or more drive shafts of the downstream portion 131B.

Referring now to FIG. 1C, an example of a third hydraulically powered power system 100C may include any, some, or all of the components, devices, and/or systems of FIGS. 1A and/or 1B (e.g., the power source 110, the hydraulic circuit 120, the drive assembly 130, the one or more drive assembly couplers 133, the generator 140, the power conversion circuitry 141, etc.). As can be seen in the example of FIG. 1C, in the third hydraulically powered power system 100C, the one or more mechanically powered auxiliary devices 134 are coupled, by one or more auxiliary device auxiliary linkages 135A (e.g., any, some, or all of the auxiliary linkages 135), to one or more auxiliary device drive assembly couplers 133A (e.g., any, some, or all of the drive assembly couplers 133), and the flywheel 132 is coupled, by one or more flywheel auxiliary linkages 135B (e.g., any, some, or all of the auxiliary linkages 135), to one or more flywheel drive assembly couplers 133B (e.g., any, some, or all of the drive assembly couplers 133).

In some examples, the flywheel 132 may couple directly to the one or more flywheel drive assembly couplers 133B (e.g., such that the drive assembly 130 may not include the one or more flywheel auxiliary linkages 135B) and/or include a drive assembly coupler to couple to the one or more drive shafts 131, the hydraulic motor 122, and/or the generator 140 (e.g., such that the drive assembly 130 may not include the one or more flywheel drive assembly couplers 133B and/or the one or more flywheel auxiliary linkages 135B). In some examples, the drive assembly 130 includes a plurality of flywheels 132, and, in some such examples, one or more of the flywheels of the plurality of flywheels 132 may be coupled to the one or more flywheel drive assembly couplers 133B and/or one or more of the flywheels of the plurality of flywheels 132 may not be coupled to the one or more drive assembly couplers 133B. In some such examples, one or more of the one or more flywheels of the plurality of flywheels 132 coupled to the one or more flywheel drive assembly couplers 133B may also be coupled to the one or more of the flywheel auxiliary linkages 135B and/or one or more of the one or more flywheels of the plurality of flywheels 132 coupled to the one or more flywheel drive assembly couplers 133B may be coupled to the one or more flywheel drive assembly couplers 133B without the one or more flywheel auxiliary linkages 135B.

Referring now to FIGS. 1A-1C, in some examples, the flywheel 132 and any, some, or all of the mechanically powered auxiliary devices 134 may both be coupled to a same one or more drive assembly couplers of any, some, or all of the drive assembly couplers 133, 133A, 133B. In some examples, the flywheel 132 and any, some, or all of the mechanically powered auxiliary devices 134 may both be coupled to a same one or more auxiliary linkages of any, some, or all of the auxiliary linkages 135, 135A, 135B.

In some examples, any, some, or all of the systems 100A, 100B, 100C may include the flywheel 132 (and/or one or more other flywheels) coupled to the one or more flywheel drive assembly couplers 133B and/or one or more of the flywheel auxiliary linkages 135B even, in some examples, if any, some, or all of the systems 100A, 100B, 100C do not include the one or more mechanically powered auxiliary devices 134, either or both of the drive assembly couplers 133, 133A, and/or either or both of the auxiliary linkages 135, 135B.

In some examples, the flywheel 132 (and/or one or more other flywheels) is coupled to the hydraulic motor 122. In some examples, the flywheel 132 (and/or one or more other flywheels) is directly coupled to the hydraulic motor 122. In some examples, the flywheel 132 (and/or one or more other flywheels) is coupled to the hydraulic motor 122 by one or more drive assembly couplers (e.g., the one or more flywheel drive assembly couplers 133B).

In some examples, the flywheel 132 (and/or one or more other flywheels) is coupled to the generator 140. In some examples, the flywheel 132 (and/or one or more other flywheels) is directly coupled to the generator 140. In some examples, the flywheel 132 (and/or one or more other flywheels) is coupled to the generator 140 by one or more drive assembly couplers (e.g., the one or more flywheel drive assembly couplers 133B).

In some examples, the hydraulic motor 122 provides the motor power to only one of the one or more mechanically powered auxiliary devices 134. In some examples, the hydraulic motor 122 provides the motor power to any plurality of the one or more mechanically powered auxiliary devices 134. In some examples, the hydraulic motor 122 provides the motor power to none of the one or more mechanically powered auxiliary devices 134. In some examples, any, some, or all of the systems 100A, 100B, 100C include only one of the one or more mechanically powered auxiliary devices 134. In some examples, any some, or all of the systems 100A, 100B, 100C include none of the one or more mechanically powered auxiliary devices 134. In some examples, any some, or all of the systems 100A, 100B, 100C include any plurality of the one or more mechanically powered auxiliary devices 134.

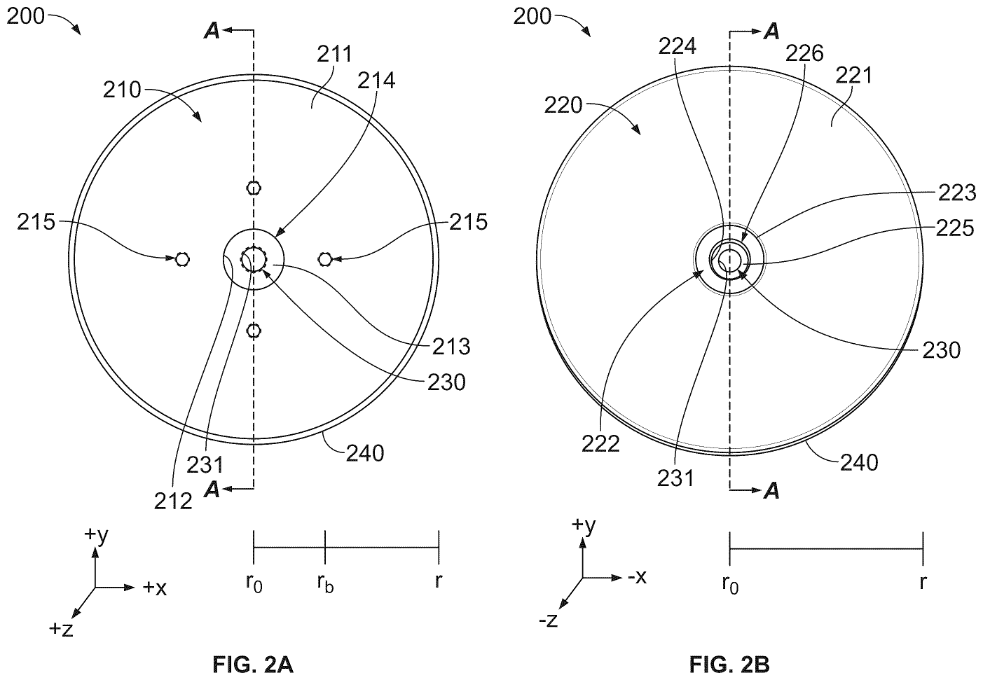

Referring now to FIGS. 2A and 2B, a first end 210 of an example of a flywheel 200 is depicted in FIG. 2A, while a second end 220 of the flywheel 200 opposite the first end 210 is depicted in FIG. 2B. The ends 210, 220 are separated by an exterior circumferential surface 240 of the flywheel 200. In some examples, the flywheel 200 may be used as the flywheel 132 of any, some, or all of the systems 100A, 100B, 100C, and/or as one or more other flywheels of any, some, or all of the systems 100A, 100B, 100C and/or one or more other hydraulically powered power systems.

Referring to FIG. 2A, the first end 210 includes a first end surface 211 extending from the exterior circumferential surface 240 to a first interior circumferential surface 212 of the first end 210. The first end 210 defines a radius (r). In some examples, the radius (r) is greater than or equal to 4 inches and less than or equal to 4.5 inches. In other examples, the radius (r) may be any length. In some examples, the first end surface 211 is planar or substantially planar between the exterior circumferential surface 240 and the first interior circumferential surface 212 (i.e., even with and/or parallel to the x-y plane of FIG. 2A. In some examples, the first end surface 211 defines one or more angles (e.g., in the +z and/or −z directions of FIG. 2A) between the exterior circumferential surface 240 and the first interior circumferential surface 212.

The first interior circumferential surface 212 extends from the first end surface 211 to a first end inner surface 213 (e.g., at least partially in the −z direction of FIG. 2A). In the example of FIG. 2A, the surfaces 212, 213 thereby define a first end receiving space 214. In some examples, the flywheel 200 receives a first end of a drive shaft (e.g., one or more of the one or more drive shafts 131) in the first end receiving space 214. In some such examples, a second end of the drive shaft opposite the first end may couple to, e.g., the hydraulic motor 122, the generator 140, any, some, or all of the drive assembly couplers 133, and/or one or more other devices, systems, and/or components. In some examples, the first interior circumferential surface 212, the first end inner surface 213, and/or the first end receiving space 214 may be configured to conform to, mate with, and/or otherwise engage one or more surfaces of a drive shaft (e.g., the one or more drive shafts 131), a drive assembly coupler (e.g., the one or more flywheel drive assembly couplers 133B), a motor (e.g., the hydraulic motor 122), a generator (e.g., the generator 140), and/or one or more other devices, systems, and/or components. For example, either or both of the surfaces 212, 213 may be configured to define a tapered fit with one or more exterior surfaces of a drive shaft.

The first end inner surface 213 extends from the first interior circumferential surface 212 to a through hole circumferential surface 231, which defines a through hole 230 extending through some or all of the flywheel 200 (e.g., parallel or substantially parallel to the exterior circumferential surface 240). In some examples, the flywheel 200 may not include the first end inner surface 213. In some such examples, the circumferential surfaces 212, 231 may be the same surface. In some examples, a drive shaft (e.g., a drive shaft of the one or more drive shafts 131) may extend through the through hole 230. In some examples, an end of a drive shaft (e.g., a drive shaft of the one or more drive shafts 131) may extend toward and/or up to the first end inner surface 213.

In some examples, the flywheel 200 defines one or more boreholes 215 extending from the first end surface 211. In the example of FIG. 2A, the boreholes 215 are positioned along a circumference defined by a borehole radius (r_{b}). In some examples, one or more of the boreholes 215 may be positioned at one or more different radii than one or more other boreholes of the boreholes 215. In some examples, the flywheel 200 may include any plurality of the boreholes 215. In some examples, the flywheel 200 may include only one borehole 215. In some examples, the flywheel 200 may include none of the boreholes 215. The boreholes 215 may be configured to receive a fastener. For example, one or more of the boreholes 215 may be internally threaded to receive a threaded fastener (e.g., a screw). The boreholes 215 may be used to couple the flywheel 200 to, e.g., a drive shaft (e.g., the one or more drive shafts 131), a drive assembly coupler (e.g., the one or more flywheel drive assembly couplers 133B), a motor (e.g., the hydraulic motor 122), a generator (e.g., the generator 140), and/or one or more other devices, systems, and/or components.

Referring to FIG. 2B, the second end 220 includes a second end surface 221 extending from the exterior circumferential surface 240 to a raised portion 222. In the example of FIG. 2B, the second end 220, like the first end 210, defines the radius (r) (i.e., the ends 210, 220 each define equal or substantially equal radii). In other examples, the second end 220 defines a radius greater than or less than a radius of the first end 210. In some examples, the second end surface 221 is planar or substantially planar between the exterior circumferential surface 240 and the raised portion 222 (i.e., even with and/or parallel to the x-y plane of FIG. 2B. In some examples, the second end surface 221 defines one or more angles (e.g., in the +z and/or −z directions of FIG. 2B) between the exterior circumferential surface 240 and the raised portion 222.

The raised portion 222 extends from a raised portion circumferential surface 223 to a second interior circumferential surface 224. The raised portion circumferential surface 223 extends from the second end surface 221 at least partially in the −z direction of FIG. 2B. The second interior circumferential surface 224 extends from the raised portion 222 to a second end inner surface 225 (e.g., at least partially in the +z direction of FIG. 2B). The second end inner surface 225 extends from the second interior circumferential surface 224 to the through hole circumferential surface 231. In the example of FIG. 2B, the surfaces 224, 225 thereby define a second end receiving space 226. In some examples, the flywheel 200 receives a first end of a drive shaft (e.g., one or more of the one or more drive shafts 131) in the second end receiving space 226. In some examples, any, some, or all of the raised portion 222, the raised portion circumferential surface 223, the second interior circumferential surface 224, the second end inner surface 225, and/or the second end receiving space 226 are configured to conform to, mate with, and/or otherwise engage one or more surfaces of a drive shaft (e.g., the one or more drive shafts 131), a drive assembly coupler (e.g., the one or more flywheel drive assembly couplers 133B), a motor (e.g., the hydraulic motor 122), a generator (e.g., the generator 140), and/or one or more other devices, systems, and/or components. For example, either or both of the surfaces 224, 225 may be configured to define a tapered fit with one or more exterior surfaces of a drive shaft.

In some examples, the second end 220 may include one or more boreholes (e.g., one or more boreholes similar to the boreholes 215.

Referring to FIGS. 2A and 2B, in some examples, the first end 210 may receive (e.g., in the first end receiving space 214) and/or be coupled to (e.g., via the boreholes 215, the one or more flywheel drive assembly couplers 133B, and/or the one or more flywheel auxiliary linkages 135B) a first end of a drive shaft (e.g., a drive shaft of the one or more drive shafts 131). In some such examples, a second end of the drive shaft opposite the first end may be downstream of and/or coupled to a motor (e.g., the hydraulic motor 122) or coupled to and/or upstream of a generator (e.g., the generator 140).

In some examples, the second end 220 may receive (e.g., in the second end receiving space 226) and/or be coupled to (e.g., via one or more boreholes, the one or more flywheel drive assembly couplers 133B, and/or the one or more flywheel auxiliary linkages 135B) a first end of a drive shaft (e.g., a drive shaft of the one or more drive shafts 131). In some such examples, a second end of the drive shaft opposite the first end may be downstream of and/or coupled to a motor (e.g., the hydraulic motor 122) or coupled to and/or upstream of a generator (e.g., the generator 140).

Referring still to FIGS. 2A and 2B, and with reference to FIGS. 1A-1C, in some examples, the flywheel 200 is used as the flywheel 132. In some examples, the first end 210 is coupled to the generator 140 (e.g., by one or more of the one or more flywheel drive assembly couplers 133B and/or the one or more flywheel auxiliary linkages 134B). In some examples, the first end 210 is coupled to the hydraulic motor 122 (e.g., by one or more of the one or more flywheel drive assembly couplers 133B and/or the one or more flywheel auxiliary linkages 134B). In some examples, the first end 210 is coupled to a drive shaft of the one or more drive shafts 131. In some such examples, the drive shaft of the one or more drive shafts 131 is drivingly coupled to the hydraulic motor 122 (e.g., directly coupled to the hydraulic motor 122, coupled to the hydraulic motor 122 by one or more of the one or more drive assembly couplers 133, and/or downstream of the hydraulic motor 122 within the drive assembly 130) and a second end of the drive shaft is coupled to the first end 210 of the flywheel 200.

In some examples, the second end 220 is coupled to the generator 140 (e.g., by one or more of the one or more flywheel drive assembly couplers 133B and/or the one or more flywheel auxiliary linkages 134B). In some examples, the second end 220 is coupled to the hydraulic motor 122 (e.g., by one or more of the one or more flywheel drive assembly couplers 133B and/or the one or more flywheel auxiliary linkages 134B). In some examples, the second end 220 is coupled to a drive shaft of the one or more drive shafts 131. In some such examples, the drive shaft of the one or more drive shafts 131 is drivingly coupled to the hydraulic motor 122 (e.g., directly coupled to the hydraulic motor 122, coupled to the hydraulic motor 122 by one or more of the one or more drive assembly couplers 133, and/or downstream of the hydraulic motor 122 within the drive assembly 130) and a second end of the drive shaft is coupled to the second end 220 of the flywheel 200.

In some examples, the first end 210 is coupled to a first drive shaft of the one or more drive shafts 131 and the second end 220 is coupled to a second drive shaft of the one or more drive shafts 131. In some such examples, the first drive shaft is drivingly coupled to the hydraulic motor 122 at a first end of the second drive shaft (e.g., directly coupled to the generator 140, coupled to the generator 140 by one or more of the one or more drive assembly couplers 133, and/or upstream of the generator 140 within the drive assembly 130) and a second end of the second drive shaft (opposite the first end) is coupled to the second end 220 of the flywheel 200. In some examples, the first end 210 is coupled to the hydraulic motor 122 and the second end 220 is coupled to a drive shaft of the one or more drive shafts 131. In some examples, the first end 210 is coupled to the generator 140 and the second end 220 is coupled to a drive shaft of the one or more drive shafts 131.

In some examples, both ends of the flywheel 200 are configured as one or more examples of the first end 210. In some examples, both ends of the flywheel 200 are configured as one or more examples of the second end 220. In some examples, one end of the flywheel 200 is configured as the examples of either of the ends 210, 220, while the other end is differently configured than the examples of either of the ends 210, 220.

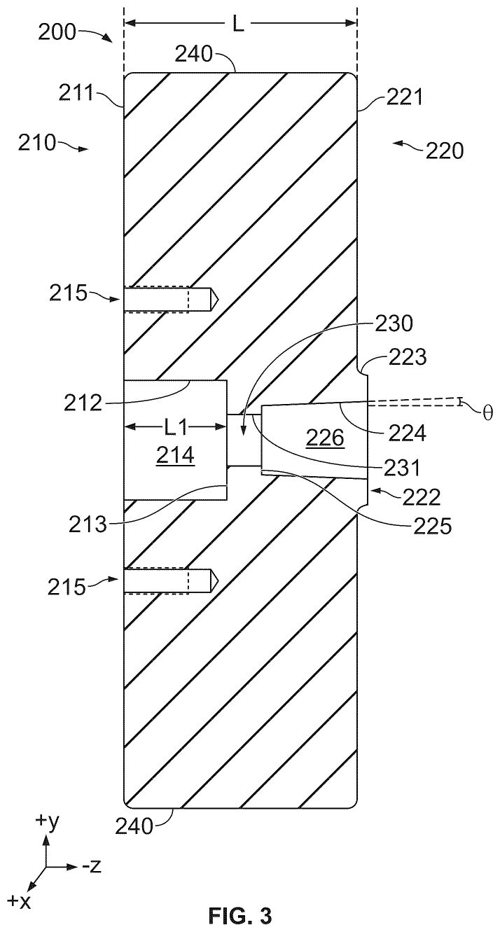

Referring now to FIG. 3, and with reference to FIGS. 2A and 2B, a cross section of the flywheel 200 is depicted along the axis A-A of FIGS. 2A and 2B. As can be seen in FIG. 3, the exterior circumferential surface 240 defines a length (L) of the flywheel 200 between the first end 210 and the second end 220. In some examples, the length (L) of the flywheel 200 is greater than or equal to 2.25 inches and less than or equal to 3.5 inches. In other examples, the length (L) of the flywheel 200 may be any length.

In the example of FIG. 3, the radius (r) of the flywheel 200 is substantially constant along the length (L) of the flywheel 200 between the ends 210, 220. However, in other examples, the radius (r) of the flywheel 200 may vary along any, some, or all of the length (L) of the flywheel 200.

In the example of FIG. 3, the length (L) of the flywheel 200 is substantially constant along the radius (r) of the flywheel 200. However, in other examples, the length (L) of the flywheel 200 may vary along any, some, or all of the radius (r) of the flywheel 200.

In the example of FIG. 3, a density of the flywheel 200 is substantially constant along the radius (r) of the flywheel and along the length (L) of the flywheel 200. However, in other examples, a density of the flywheel 200 may vary along the radius (r) of the flywheel and/or along the length (L) of the flywheel 200. In the example of FIG. 3, because the radius (r), the length (L), and the density of the flywheel 200 are each substantially constant across most or all of the flywheel 200, a mass of the flywheel 200 is evenly distributed across most or all of the flywheel 200. However, in some examples, any, some, or all of the radius (r), the length (L), and/or the density of the flywheel 200 may vary across any, some, or all of the flywheel 200 and/or remain constant across any, some, or all of the flywheel 200. In some such examples, a mass of the flywheel 200 may, thereby, be more concentrated at one or more portions of the flywheel 200 than at one or more other portions of the flywheel 200 (e.g., concentrated toward the exterior circumferential surface 240). For example, the flywheel 200 may be designed to 1

As can be seen in the example of FIG. 3, the second interior circumferential surface 224 extends at an angle (θ) (relative to, e.g., the z-axis of FIG. 3 and/or an axis perpendicular to the second end inner surface 225). Accordingly, in the example of FIG. 3, the second interior circumferential surface 224 is a tapered surface. By being tapered, the second interior circumferential surface 224 (and, thereby, the second end receiving space 226) may define a tapered fit with an exterior surface of an end of a drive shaft (e.g., a drive shaft of the one or more drive shafts 131) to couple the second end 220 of the flywheel 200 to the drive shaft. In some additional and/or alternative examples, the second end inner surface 225 may define an angle relative to, e.g., any, some, or all of the x-, y-, and/or z-axes of FIG. 3 to, e.g., define a tapered surface and/or a tapered fit with a drive shaft additionally to and/or alternatively to a tapered surface and/or a tapered fit defined by the second interior circumferential surface 224.

In some examples, the first interior circumferential surface 212 may extend at an angle (relative to, e.g., the z-axis of FIG. 3 and/or an axis perpendicular to the first end inner surface 213). Accordingly, in the example of FIG. 3, the first interior circumferential surface 212 may be a tapered surface. By being tapered, the first interior circumferential surface 212 (and, thereby, the second end receiving space 226) may define a tapered fit with an exterior surface of an end of a drive shaft (e.g., a drive shaft of the one or more drive shafts 131) to couple the first end 210 of the flywheel 200 to the drive shaft. In some additional and/or alternative examples, the second end inner surface 225 may define an angle relative to, e.g., any, some, or all of the x-, y-, and/or z-axes of FIG. 3 to, e.g., define a tapered surface and/or a tapered fit with a drive shaft additionally to and/or alternatively to a tapered surface and/or a tapered fit defined by the second interior circumferential surface 224.

In some examples, any, some, or all of the surfaces 212, 213, 224, 225 may be tapered. In some examples, none of the surfaces 212, 213, 224, 225 may be tapered.

Referring again to FIGS. 1A-1C, in some examples, any, some, or all of the systems 100A, 100B, 100C do not include the power conversion circuitry 141. In some examples, any, some, or all of the systems 100A, 100B, 100C include the power conversion circuitry 141 as the sole power conversion circuitry of the system 100. In other examples, any, some, or all of the systems 100A, 100B, 100C may include a plurality of power conversion circuitries including the power conversion circuitry 141 and one or more additional power conversion circuitries. In some such examples, functions of the power conversion circuitry 141 described herein may be performed individually by the power conversion circuitry 141 and/or collectively by a plurality of power conversion circuitries including the power conversion circuitry 141. In some examples, any, some, or all of the systems 100A, 100B, 100C include a plurality of generators. In some such examples, one or more generators of a plurality of generators of any, some, or all of the systems 100A, 100B, 100C provide a respective electrical output to one or more respective power conversion circuitries of a plurality of power conversion circuitries. In some examples, the generator 140 provides the electrical output to a plurality of power conversion circuitries including the power conversion circuitry 141.

In some examples, any, some, or all of the systems 100A, 100B, 100C include the generator 140 as the sole generator of any, some, or all of the systems 100A, 100B, 100C. In other examples, any, some, or all of the systems 100A, 100B, 100C may include a plurality of generators including the generator 140 and one or more additional generators. In some such examples, functions of the generator 140 described herein may be performed individually by the generator 140 and/or collectively by a plurality of generators including the generator 140. In some examples, any, some, or all of the systems 100A, 100B, 100C include a plurality of hydraulic motors (e.g., by including a plurality of hydraulic circuits and/or by the hydraulic circuit 120 including a plurality of hydraulic motors) and/or one or more other type(s) of motors. In some such examples, one or more generators of a plurality of generators of any, some, or all of the systems 100A, 100B, 100C receive a respective motor power from a respective hydraulic motor and/or other type of motor. In some examples, the hydraulic motor 122 provides the motor power to a plurality of generators including the generator 140.

In the examples of FIGS. 1A-1C, the systems 100A, 100B, 100C include a control circuitry 150. In some examples, the control circuitry 150 is and/or includes one or more control circuitries integrated into one or more components, systems, and/or devices of the system 100 (e.g., as a computing device electrically coupled to the generator 140 and integrated into a housing of the generator 140). In some additional and/or alternative examples, the control circuitry 150 is and/or includes one or more remote control circuitries (e.g., one or more cloud computing devices and/or systems, one or more cloud memory storage devices and/or systems, one or more remote controls, one or more smartphones, one or more laptops, etc.) which may, e.g., remotely transmit and/or receive signals to one or more components, systems, and/or devices of the system 100.

The control circuitry 150 may be electrically coupled to one or more devices, systems, and or components of any, some, or all of the systems 100A, 100B, 100C. In some examples, the control circuitry 150 may control one or more devices, systems, and/or components of any, some, or all of the systems 100A, 100B, 100C. For example, the control circuitry 150 may control one or more devices, systems, and/or components of any, some, or all of the systems 100A, 100B, 100C by transmitting a control signal that controls the one or more devices, systems, and/or components of any, some, or all of the systems 100A, 100B, 100C to modify a function, an operation, one or more operation characteristics, etc. of the one or more devices, systems, and/or components of any, some, or all of the systems 100A, 100B, 100C (e.g., controlling the welding torch of the one or more tools 142 to turn on/off, modifying an engine speed of the power source 110, etc.).

While the present method, apparatus, and/or system has been described with reference to certain implementations, it will be understood by those skilled in the art that various changes, modifications, and variations may be made to the present disclosure and equivalents may be substituted without departing from the scope of the present disclosure. In addition, many modifications may be made to adapt a particular situation or material to the teachings of the present disclosure without departing from its scope. For example, systems, blocks, and/or other components of disclosed examples may be combined, divided, re-arranged, and/or otherwise modified. Therefore, the present method and/or system are not limited to the particular implementations disclosed. Instead, the present method and/or system will include all implementations falling within the scope of the appended claims, both literally and under the doctrine of equivalents.

What is claimed is:

1. A hydraulically powered power system comprising:
a hydraulic motor configured to convert an input hydraulic flow to motor power;
a drive assembly drivingly coupled to the hydraulic motor to receive the motor power, the drive assembly comprising one or more drive shafts;
a generator drivingly coupled to the drive assembly and configured to convert the motor power to an electrical output; and
a flywheel drivingly coupled to at least one of the one or more drive shafts of the drive assembly, wherein the flywheel is configured to resist changes in a rotational speed of the drive assembly.

2. The hydraulically powered power system of claim 1, further comprising power conversion circuitry electrically coupled to the generator and configured to convert the electrical output to welding-type power.

3. The hydraulically powered power system of claim 1, further comprising output equipment configured to receive the electrical output from the generator.

4. The hydraulically powered power system of claim 2, further comprising power conversion circuitry electrically coupled to the generator and configured to convert the electrical output to welding-type power, wherein the output equipment comprises a welding torch configured to receive the welding-type power from the power conversion circuitry.

5. The hydraulically powered power system of claim 2, wherein the output equipment comprises an air compressor.

6. The hydraulically powered power system of claim 1, further comprising output equipment configured to receive the motor power from the drive assembly, wherein the drive assembly further comprises one or more drive assembly couplers configured to drivingly couple the output equipment to at least one of the one or more drive shafts of the drive shaft.

7. The hydraulically powered power system of claim 6, wherein the output equipment comprises an air compressor.

8. The hydraulically powered power system of claim 1, wherein:
the drive assembly further comprises one or more drive assembly couplers; and
the flywheel is coupled to at least one of the one or more drive assembly couplers to drivingly couple the flywheel to the at least one drive shaft of the one or more drive shafts.

9. The hydraulically powered power system of claim 8, wherein the one or more drive assembly couplers comprise at least one of a gearbox, a drive shaft mount, a flange mount, or one or more belts.

10. The hydraulically powered power system of claim 1, wherein:
the one or more drive shafts comprise a first drive shaft drivingly coupled to the hydraulic motor by a first end of the first drive shaft;
the first drive shaft comprises a second end opposite the first end of the first drive shaft; and
a first end of the flywheel receives the second end of the first drive shaft to couple the flywheel to the first drive shaft.

11. The hydraulically powered power system of claim 10, wherein:
the first end of the flywheel comprises an interior tapered surface;
the second end of the first drive shaft comprises an exterior tapered surface; and
the interior tapered surface of the first end of the flywheel and the exterior tapered surface of the second end of the first drive shaft are configured to define a tapered fit to couple the flywheel to the first drive shaft.

12. The hydraulically powered power system of claim 10, wherein:
the or more drive shafts further comprise a second drive shaft drivingly coupled to the generator by a first end of the second drive shaft;
the second drive shaft further comprises a second end opposite the first end of the second drive shaft;
the flywheel further comprises a second end opposite the first end of the flywheel; and
the second end of the flywheel is coupled to the second end of the second drive shaft.

13. The hydraulically powered power system of claim 10, wherein:
the drive assembly further comprises one or more drive assembly couplers;
the flywheel further comprises a second end opposite the first end of the flywheel; and
the one or more drive assembly couplers are configured to couple to the second end of the flywheel to drivingly couple the generator to the flywheel.

14. The hydraulically powered power system of claim 1, wherein the flywheel is coupled to the hydraulic motor.

15. The hydraulically powered power system of claim 1, wherein the flywheel is coupled to the generator.

16. The hydraulically powered power system of claim 1, wherein the flywheel defines a radius greater than or equal to 4 inches and less than or equal to 4.5 inches.

17. The hydraulically powered power system of claim 1, wherein the flywheel defines a length greater than or equal to 2.25 inches and less than or equal to 3.5 inches.

18. The hydraulically powered power system of claim 1, further comprising a hydraulic pump configured to receive input power and to convert the input power to the input hydraulic flow, wherein the hydraulic pump is hydraulically coupled to the hydraulic motor to form a hydraulic circuit.

19. The hydraulically powered power system of claim 18, further comprising a power source configured to generate the input power, wherein the hydraulic pump is drivingly coupled to the power source to receive the input power.

20. The hydraulically powered power system of claim 19, wherein the power source is an engine.
